(19) United States
(12) Patent Application Publication
(10) Pub. No.: US 2026/0279259 A1
(43) Pub. Date: Sep. 17, 2026

(54) CIRCUIT BOARD

(71) Applicant: Sharp Kabushiki Kaisha, Sakai City (JP)

(72) Inventors: Tadayoshi MIYAMOTO, Sakai City (JP); Naoki MAKITA, Sakai City (JP); Yoshinobu NAKAMURA, Sakai City (JP); Toshihiro KANEKO, Sakai City (JP); Sohtaroh TANAKA, Sakai City (JP)

(21) Appl. No.: 19/564,575

(22) Filed: Mar. 12, 2026

(30) Foreign Application Priority Data
Mar. 14, 2025 (JP) 2025-041828

(51) Int. Cl. G09G 3/32; G09G 3/3208

(52) U.S. Cl. CPC G09G 3/32; G09G 3/3208; G09G 2320/0233; G09G 2320/0295; G09G 2320/046

(57) ABSTRACT

A circuit board includes: an effective region having a first driving transistor configured to drive a first driven target object by a current, and a second driving transistor configured to drive a second driven target object by a current; and an external output terminal connected to a conduction terminal of the second driving transistor, wherein an output current value of the second driving transistor is larger than an output current value of the first driving transistor when an identical value of voltage is applied to a gate terminal of the first driving transistor and a gate terminal of the second driving transistor.

### CROSS-REFERENCE TO RELATED APPLICATION

The present application claims priority from Japanese Application JP2025-041828, the content to which is hereby incorporated by reference into this application.

### BACKGROUND

### 1. Field of the Disclosure

The present disclosure relates to a circuit board.

### 2. Description of the Related Art

Japanese Unexamined Patent Application Publication No. 2010-97114 discloses a liquid crystal display in which a plurality of switching elements is formed along a bending portion of its non-display region, wherein the plurality of switching elements is connected to each other in parallel, and wherein one electrode of the switching elements is connected to a common potential.

### SUMMARY

Such a conventional technique tends to complicate a circuit for performing deterioration compensation in a driving transistor that drives a driven target object by current, so that the cost for manufacturing a device provided with a circuit board may increase.

A circuit board according to one aspect of the present disclosure includes the following: an effective region having a first driving transistor configured to drive a first driven target object by a current, and a second driving transistor configured to drive a second driven target object by a current; and an external output terminal connected to a conduction terminal of the second driving transistor. An output current value of the second driving transistor is larger than an output current value of the first driving transistor when an identical value of voltage is applied to a gate terminal of the first driving transistor and a gate terminal of the second driving transistor.

The aspect of the present disclosure can reduce the cost for manufacturing a device provided with a circuit board.

### BRIEF DESCRIPTION OF THE DRAWINGS

FIG. 1 is a plan view of the configuration of a circuit board according to an embodiment of the present disclosure;

FIG. 2 illustrates the configuration of a first unit circuit;

FIG. 3 illustrates the configuration of a second unit circuit;

FIG. 4 is a plan view of the configuration of a unit circuit;

FIG. 5 is a cross-sectional view taken along line A-A′ in FIG. 4;

FIG. 6 is a cross-sectional view taken along line B-B′ in FIG. 4;

FIG. 7 is a plan view of the configuration of a first driving transistor, and a cross-sectional view of the same taken along line C-C′;

FIG. 8 is a plan view of the configuration of a second driving transistor, and a cross-sectional view of the same taken along line D-D′;

FIG. 9 is a cross-sectional view of an example configuration of the circuit board according to the embodiment of the present disclosure;

FIG. 10 is a table showing the configuration of each layer in the cross section illustrated in FIG. 9; and

FIG. 11 is a flowchart showing deterioration compensation in the first driving transistor.

### DESCRIPTION OF EMBODIMENTS

An embodiment of the present disclosure will be described. For convenience in description, components having the same functions as those of earlier described components will be denoted by the same signs, and their description will not be repeated in some cases.

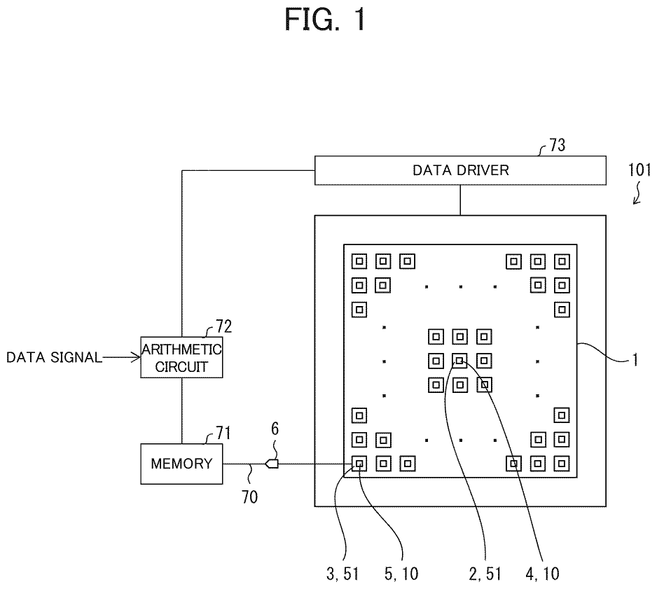

FIG. 1 is a plan view of the configuration of a circuit board 101 according to an embodiment of the present disclosure. The circuit board 101 has an effective region 1. The effective region 1 is a region for implementing the main functions of a device provided with the circuit board 101. When this device is a display device, the effective region 1 may be a region provided with various components necessary for image display. Other than the foregoing, the effective region 1 may be a region provided with various components necessary for measurement in a non-display device, such as a sensor.

The effective region 1 has a plurality of unit circuits 51. The plurality of unit circuits 51 is located in matrix. One of the plurality of unit circuits 51 is a first unit circuit 2. One of the plurality of unit circuits 51 different from the first unit circuit 2 is a second unit circuit 3.

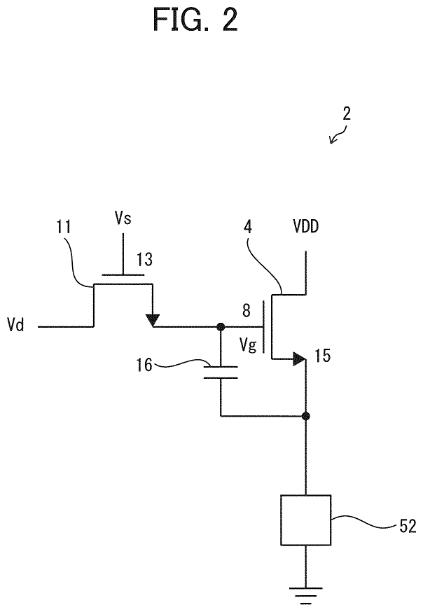

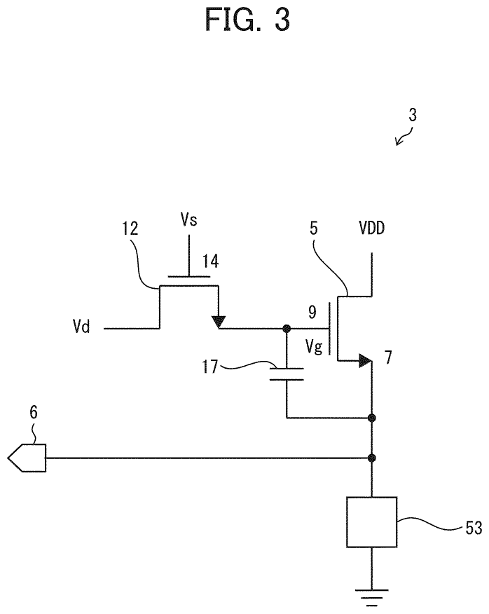

FIG. 2 illustrates the configuration of the first unit circuit 2. FIG. 3 illustrates the configuration of the second unit circuit 3.

The first unit circuit 2 is connected to a first driven target object 52. The first unit circuit 2 has a first driving transistor 4. The first driving transistor 4 is connected to the first driven target object 52 and drives the first driven target object 52 by current.

The second unit circuit 3 is connected to a second driven target object 53. The second unit circuit 3 has a second driving transistor 5. The second driving transistor 5 is connected to the second driven target object 53 and drives the second driven target object 53 by current.

When a device provided with the circuit board 101 is a display device, an example of each of the first driven target object 52 and second driven target object 53 is a self-luminous element. Examples of the self-luminous element include an organic light-emitting diode (OLED) element and a quantum light-emitting diode (QLED) element. Other than the foregoing, an example of each of the first driven target object 52 and second driven target object 53 is a light-receiving element or light-emitting element for measurement in a sensor.

The circuit board 101 includes an external output terminal 6. The external output terminal 6 is connected to a conduction terminal 7 of the second driving transistor 5. When an identical value of voltage Vg is applied to a gate terminal 8 of the first driving transistor 4 and a gate terminal 9 of the second driving transistor 5, an output current value of the second driving transistor 5 is larger than an output current value of the first driving transistor 4.

The configuration of the first driving transistor 4 and second driving transistor 5 aims to overcome a problem in circuit boards. Supplying a large current to the second driving transistor 5 can eliminate a malfunction in the effective region. The output current of the second driving transistor 5 can be monitored from the external output terminal 6.

When a device provided with a circuit board is a display device, a problem of the circuit board is luminance variations (unevenness and burn-in) caused by characteristic variations of driving transistors. Conventionally, a compensation circuit has been provided separately from a circuit board, thereby preventing luminance change for each of a plurality of pixels in real time; however, this function of prevention becomes complicated along with increase in precision. It is said that luminance change (fluctuation) is considerably attributed to fluctuations in the threshold value of driving transistors; to monitor these fluctuations, it is ideal to monitor fluctuations that occur along a data signal. When a device provided with a circuit board is a display device, this data signal may be a video signal.

Conventionally, current behavior (deterioration) has been estimated in advance by the use of a test element group (TEG) element provided in a region (a cutaway portion of a mother board) different from the circuit board, and the actual state of current has been fed back in line with the estimated amount.

In this case, high precision causes a system-inclusive algorithm to become easily complicated in current monitoring for each of a plurality of driving transistors. This can increase the cost for manufacturing a device provided with a circuit board.

The method with a TEG element is merely monitoring with reference to a single driving transistor; this monitoring tends to be further emphasized than monitoring with reference to a unit circuit. This method is monitoring based on driving transistor's threshold fluctuation resulting from DC voltage application and can be thus different from monitoring based on driving transistor's threshold fluctuation resulting from AC voltage application during the operation of a unit circuit.

As an approach in view of the design of the circuit board 101, the circuit board 101 is provided with the second driving transistor 5 so that the second driving transistor 5 can be supplied with a larger current than the first driving transistor 4.

The size of the second driving transistor 5 is different from the size of the first driving transistor 4 intentionally. Assuming that an input signal for the first unit circuit 2 and an input signal for the second unit circuit 3 are supplied simultaneously to the first unit circuit 2 and second unit circuit 3, the output current value of the second driving transistor 5 is set larger than the output current value of the first driving transistor 4. As such, when these input signals are identical, a sign of deterioration of the second driving transistor 5 can be detected more prominently than a sign of deterioration of the first driving transistor 4. Using a current flowing through the external output terminal 6 enables deterioration compensation in the first driving transistor 4. Detecting current change for each of a plurality of highly precise driving transistors 10 through averaging by the use of the second driving transistor 5 provided, for instance, on the periphery of the effective region 1 enables prediction with less influence of variations as a whole.

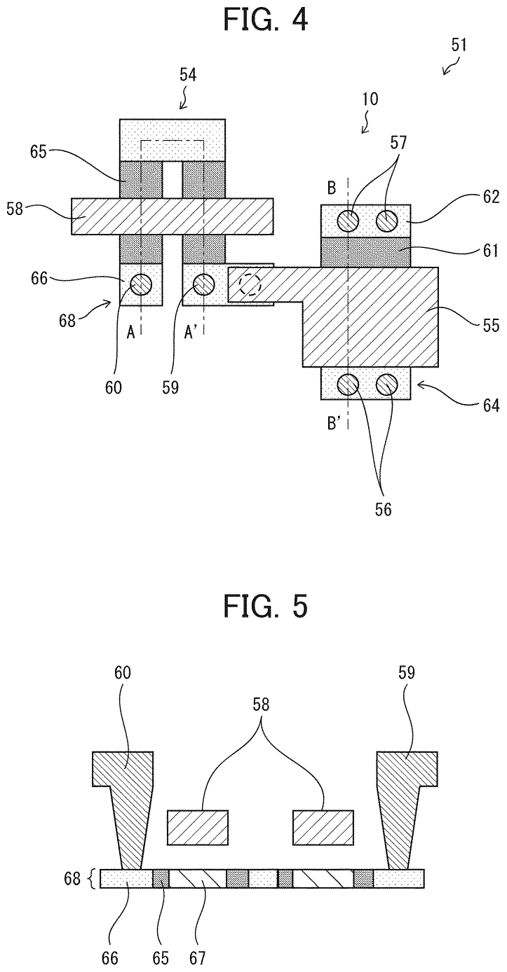

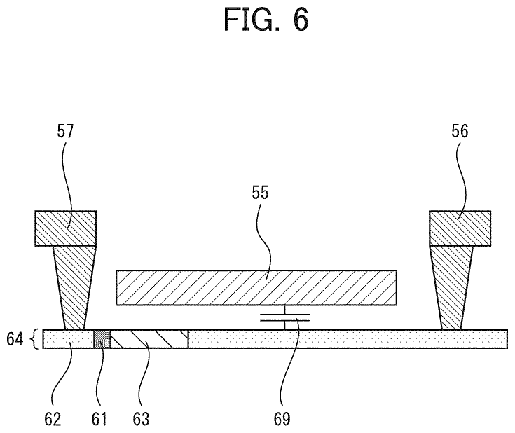

FIG. 4 is a plan view of the configuration of the unit circuit 51. FIG. 5 is a cross-sectional view taken along line A-A′ in FIG. 4. FIG. 6 is a cross-sectional view taken along line B-B′ in FIG. 4.

Each driving transistor 10 includes a gate electrode 55, a first conduction electrode 56, and a second conduction electrode 57. A selection transistor 54 includes a gate electrode 58, a first conduction electrode 59, and a second conduction electrode 60.

The driving transistor 10 has a semiconductor 64 including the following: a low-concentration portion 61; a high-concentration portion 62; and a channel portion 63 facing the gate electrode 55. The impurity concentration of the high-concentration portion 62 is higher than the impurity concentration of the low-concentration portion 61, and the impurity concentration of the channel portion 63 is lower than the impurity concentration of the low-concentration portion 61. The selection transistor 54 has a semiconductor 68 including the following: a low-concentration portion 65; a high-concentration portion 66; and a channel portion 67 facing the gate electrode 58. The impurity concentration of the high-concentration portion 66 is higher than the impurity concentration of the low-concentration portion 65, and the impurity concentration of the channel portion 67 is lower than the impurity concentration of the low-concentration portion 65. At least one of the channel portions 63 and 67 may not include impurities.

The driving transistor 10 further has a capacitive element 69 formed between the gate electrode 55 and the high-concentration portion 62.

The circuit board 101 requires to increase the precision of the unit circuits 51. The circuit board 101 includes a plurality of unit circuits 51 arranged in matrix and each having the driving transistor 10, selection transistor 54, and capacitive element 69.

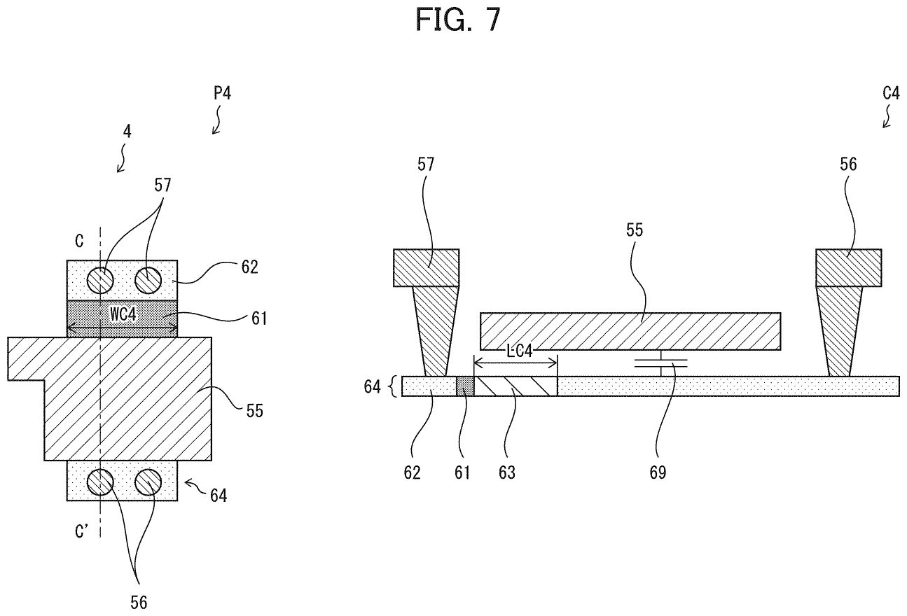

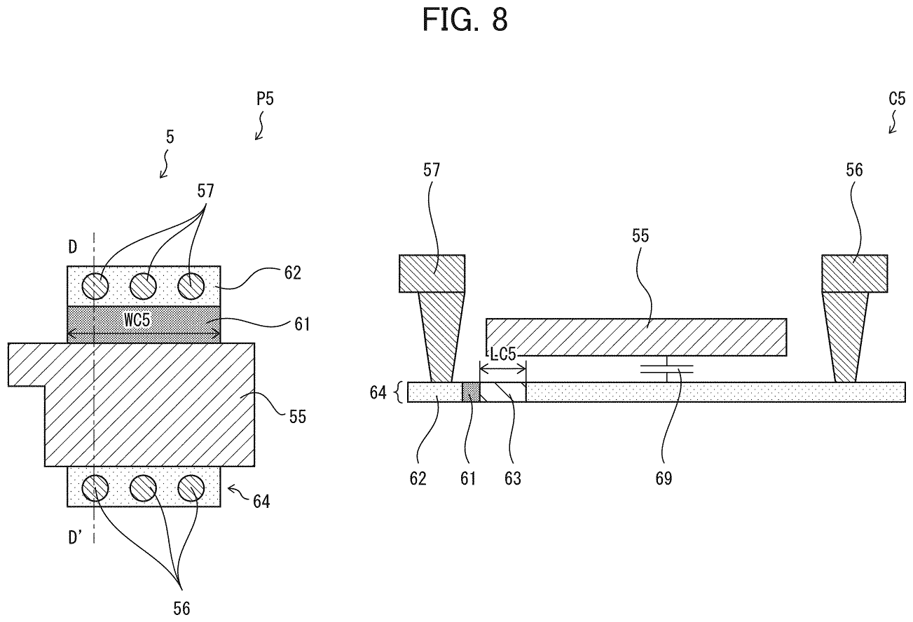

FIG. 7 is a plan view P4 of the configuration of the first driving transistor 4, and a cross-sectional view C4 of the same taken along line C-C′. FIG. 8 is a plan view P5 of the configuration of the second driving transistor 5, and a cross-sectional view C5 of the same taken along line D-D′. The conduction terminal 7 corresponds to the first conduction electrode 56. The gate terminal 8 corresponds to the gate electrode 55. The gate terminal 9 corresponds to the gate electrode 55.

A channel length LC5 of the second driving transistor 5 may be shorter than a channel length LC4 of the first driving transistor 4. A channel width WC5 of the second driving transistor 5 may be wider than a channel width WC4 of the first driving transistor 4. This can achieve a configuration where, when an identical value of voltage Vg is applied to the gate terminals 8 and 9, the output current value of the second driving transistor 5 is larger than the output current value of the first driving transistor 4.

It is well known to shorten the channel length of a thin-film transistor (TFT) and widen the channel width of the TFT in order to increase the output current value of the TFT; the circuit board 101 as well can sufficiently achieve a large output current value in line with this commitment. At a small interval between the two unit circuits 51 adjacent to each other, it is preferable to shorten the channel length LC5 due to restrictions on the occupied area of the driving transistors 10. Shortening the channel length LC5 and widening the channel width WC5 may be combined.

In the effective region 1, the second driving transistor 5 may be located further outside than the first driving transistor 4. Providing the second driving transistor 5 on the outside within the effective region 1 facilitates providing the external output terminal 6, and reduces the possibility that the main function of the center portion of the effective region 1 may be inhibited.

The effective region 1 may have a plurality of driving transistors 10 including the first driving transistor 4 and second driving transistor 5, and the plurality of driving transistors 10 may be located in matrix.

The circuit board 101 may include a first selection transistor 11 and a second selection transistor 12. The first selection transistor 11 is connected to the gate terminal 8 of the first driving transistor 4 and has a gate terminal 13 to which a selection voltage Vs is applied. The second selection transistor 12 is connected to the gate terminal 9 of the second driving transistor 5 and has a gate terminal 14 to which the selection voltage Vs is applied.

The first selection transistor 11 may perform turning-on and turning-off in accordance with a value of the selection voltage Vs applied to the gate terminal 13, and in accordance with the turning-on and turning-off, the first selection transistor 11 may control whether to apply the voltage Vg based on a signal voltage Vd to the gate terminal 8. The second selection transistor 12 may perform turning-on and turning-off in accordance with a value of the selection voltage Vs applied to the gate terminal 14, and in accordance with the turning-on and turning-off, the second selection transistor 12 may control whether to apply the voltage Vg based on the signal voltage Vd to the gate terminal 9.

An example of the signal voltage Vd is a signal voltage that is supplied from a signal line (data line) of a display device. The signal line connected to the first selection transistor 11 and the signal line connected to the second selection transistor 12 may or may not be the same. The value of the voltage Vg applied to the gate terminal 8 and the value of the voltage Vg applied to the gate terminal 9 may or may not be the same. The wording “When an identical value of voltage Vg is applied to a gate terminal 8 of the first driving transistor 4 and a gate terminal 9 of the second driving transistor 5” is merely one of many states that are possible as combinations of the value of the voltage Vg applied to the gate terminal 8 and the value of the voltage Vg applied to the gate terminal 9.

An example of the selection voltage Vs is row selection voltage that is supplied from a scanning line of a display device. The scanning line connected to the gate terminal 13 and the scanning line connected to the gate terminal 14 may or may not be the same. Th value of the selection voltage Vs applied to the gate terminal 13 and the value of the selection voltage Vs applied to the gate terminal 14 may or may not be the same.

The effective region 1 may have a plurality of selection transistors 54 including the first selection transistor 11 and the second selection transistor 12, and the plurality of selection transistors 54 may be located in matrix. The gate terminal 13 corresponds to the gate electrode 58. The gate terminal 14 corresponds to the gate electrode 58.

The circuit board 101 may include a first capacitive element 16 connected between the gate terminal 8 and a conduction terminal 15 of the first driving transistor 4, and a second capacitive element 17 connected between the gate terminal 9 and conduction terminal 7 of the second driving transistor 5. The conduction terminal 15 corresponds to the first conduction electrode 56. The first capacitive element 16 corresponds to the capacitive element 69. The second capacitive element 17 corresponds to the capacitive element 69.

The circuit board 101 may include the following: the first unit circuit 2 having the first driving transistor 4, the first selection transistor 11, and the first capacitive element 16; and the second unit circuit 3 having the second driving transistor 5, the second selection transistor 12, and the second capacitive element 17.

The first unit circuit 2 and the second unit circuit 3 may be formed through an identical process. This can reduce the number of steps for producing the first unit circuit 2 and second unit circuit 3.

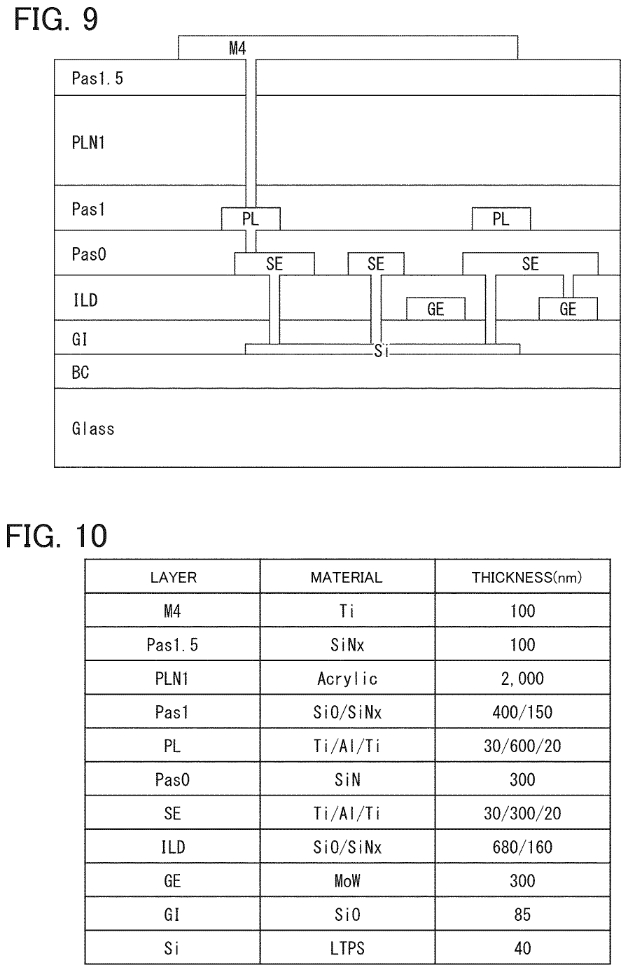

FIG. 9 is a cross-sectional view of an example configuration of the circuit board 101 according to the embodiment of the present disclosure. FIG. 10 is a table showing the configuration of each layer in the cross section illustrated in FIG. 9. The definitions of the terms in FIGS. 9 and 10 are as follows.

M4: a wiring line or electrode connected to the first driven target object 52 or second driven target object 53
Pas1.5, Pas1, and Pas0: a passivation film
PLN1: a flattening film
PL: a power supply line (potential: VDD)
SE: a source electrode of each transistor of the circuit board 101
ILD and GI: an insulating film
GE: a gate electrode of each transistor of the circuit board 101
Si: a low-temperature polysilicon (LTPS) layer
BC: a base coat layer
Glass: a base material made of glass
An anode, of the first driven target object 52 or second driven target object 53, having a laminated structure of indium tin oxide (ITO), Ag, and ITO may be formed above M4.

Referring to Si, although the foregoing has described an instance where each transistor of the circuit board 101 is an N-channel TFT, at least one transistor of the circuit board 101 may be a P-channel TFT. Since LTPS-TFTs, which have high mobility, are advantageous for forming small TFTs, this embodiment is presented on the premise that each transistor of the circuit board 101 is a LTPS-TFT; however, each transistor of the circuit board 101 may be an oxide semiconductor TFT.

The circuit board 101 may enable deterioration compensation in the first driving transistor 4 by using a current flowing through the external output terminal 6.

Typically, in a self-luminous display panel like an OLED display panel, a signal is applied to a driving transistor. In this case, to compensate for luminance unevenness and burn-in resulting from continuous display, an external compensation method is known, which is compensating for variation of device characteristic by reading out the current of each pixel within the display panel to the panel outside, and measuring the current value. This external compensation method can estimate the variation accurately, but the method takes time for feedback; in particular, this problem becomes a concern along with increase in precision.

The circuit board 101 is capable of predictive compensation by the use of the second driving transistor 5 and external output terminal 6. This method, which includes mutual interpolation based on measurement data obtained from the external output terminal 6, can reduce the number of measurements and shorten the measurement time. Furthermore, treating, as an index of characteristic deterioration, this current change obtained from the external output terminal 6 (deterioration of the second driving transistor 5) by providing the second driving transistor 5 that intentionally supplies a large current is grasping a prediction on current deterioration (worst current deterioration); accordingly, it is possible to prevent a malfunction caused by characteristic change in each driving transistor 10 within the effective region 1. Feeding back the amount of deterioration of the second driving transistor 5 brings the actual effective region 1 back to a state before a large deterioration.

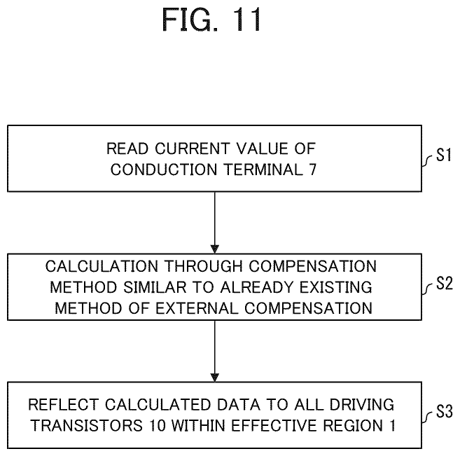

FIG. 11 is a flowchart showing deterioration compensation in the first driving transistor 4. The deterioration compensation in the first driving transistor 4 includes Steps S1 to S3. Step S1 is reading out the current value of the conduction terminal 7. Step S2 is calculation through a compensation method similar to an already existing method of external compensation. Step S3 is reflecting the calculated data to all the driving transistors 10 within the effective region 1.

In Step S1, the current value of the conduction terminal 7 is read out of a monitoring wiring line 70 connected to the external output terminal 6. In Step S2, the result of the reading-out is stored in a memory 71. The data stored in the memory 71 contains information about the current value of the conduction terminal 7 with respect to the value of the voltage Vg. If the second driving transistor 5 is deteriorated, the current value of the conduction terminal 7 is smaller than the value of the voltage Vg. In Step S2, an arithmetic circuit 72 determines the degree of deterioration of the second driving transistor 5 on the basis of the data stored in the memory 71. In Step S2, the arithmetic circuit 72 corrects a data signal on the basis of the degree of deterioration of the second driving transistor 5. In Step S3, a data driver 73 drives all the driving transistors 10 within the effective region 1 by the use of the corrected data signal. Steps S1 to S3, especially Step S2, can be implemented by a well-known technique, and thus, further detailed description will be omitted.

The present disclosure is not limited to the foregoing embodiment. Various modifications can be made within the scope of the claims. An embodiment that is obtained in combination as appropriate with technical means disclosed in respective embodiments is also encompassed within the technical scope of the present disclosure. Furthermore, combining the technical means disclosed in the respective embodiments can form a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A circuit board comprising:
an effective region having
a first driving transistor configured to drive a first driven target object by a current, and
a second driving transistor configured to drive a second driven target object by a current; and
an external output terminal connected to a conduction terminal of the second driving transistor,
wherein an output current value of the second driving transistor is larger than an output current value of the first driving transistor when an identical value of voltage is applied to a gate terminal of the first driving transistor and a gate terminal of the second driving transistor.

2. The circuit board according to claim 1, wherein a channel length of the second driving transistor is shorter than a channel length of the first driving transistor.

3. The circuit board according to claim 1, wherein a channel width of the second driving transistor is wider than a channel width of the first driving transistor.

4. The circuit board according to claim 1, wherein, in the effective region, the second driving transistor is located further outside than the first driving transistor.

5. The circuit board according to claim 1, wherein
the effective region has a plurality of driving transistors including the first and second driving transistors, and
the plurality of driving transistors is located in matrix.

6. The circuit board according to claim 1, comprising:
a first selection transistor connected to the gate terminal of the first driving transistor, and having a gate terminal to which a selection voltage is applied; and
a second selection transistor connected to the gate terminal of the second driving transistor, and having a gate terminal to which a selection voltage is applied.

7. The circuit board according to claim 6, comprising:
a first capacitive element connected between the gate terminal and a conduction terminal of the first driving transistor; and
a second capacitive element connected between the gate terminal and a conduction terminal of the second driving transistor.

8. The circuit board according to claim 7, comprising:
a first unit circuit having the first driving transistor, the first selection transistor, and the first capacitive element; and
a second unit circuit having the second driving transistor, the second selection transistor, and the second capacitive element.

9. The circuit board according to claim 8, wherein the first and second unit circuits are formed through an identical process.

10. The circuit board according to claim 1, wherein the circuit board is capable of deterioration compensation in the first driving transistor by using a current flowing through the external output terminal.
